(19) United States
(12) Patent Application Publication
(10) Pub. No.: US 2026/0145203 A1
(43) Pub. Date: May 28, 2026

(54) MULTILAYER COATING FILM

(71) Applicant: NIPPON PAINT AUTOMOTIVE COATINGS CO., LTD., Osaka (JP)

(72) Inventors: Ryoichi YONEYAMA, Osaka (JP); Ryohei TSUBONE, Osaka (JP); Shinichi FUJIWARA, Osaka (JP)

(73) Assignee: NIPPON PAINT AUTOMOTIVE COATINGS CO., LTD., Osaka (JP)

(21) Appl. No.: 19/386,946

(22) Filed: Nov. 12, 2025

(30) Foreign Application Priority Data
Nov. 26, 2024 (JP) 2024-205657

(51) Int. Cl. B05D 5/06; B05D 7/00

(52) U.S. Cl. CPC B05D 5/066; B05D 7/572; B05D 7/577; B05D 2202/15; B05D 2401/20; B05D 2601/02; B05D 2602/00

(57) ABSTRACT

A multilayer coating film including a first base coating film, a second base coating film, and a clear coating film, wherein in the water-borne first base coating composition, a luster pigment and two or more coloring pigments are contained, a solid component concentration NV1 is 20 to 35% by mass, PWC_{G1} of the luster pigment is 1 to 25%, and PWC_{C1} of the coloring pigments is 0.1 to 5.0%; and in the water-borne second base coating composition, a luster pigment and two or more coloring pigments having the same Color Index names as those of the coloring pigments contained in the water-borne first base coating composition are contained, a solid component concentration NV2 is 7 to 30% by mass, PWC_{G2} of the luster pigment is 5 to 35%, and PWC_{C2} of the coloring pigments is 0.5 to 20.0%.

### TECHNICAL FIELD

The present invention relates to a multi-layer coating film.

### BACKGROUND ART

A plurality of coating films (a multilayer coating film) are laminated on a vehicle body of an automobile. The multilayer coating film protects the vehicle body and, at the same time, imparts a superior design property to the automobile. In the multilayer coating film, for example, a first base coating film, a second base coating film, and a clear coating film are laminated in this order. Conventionally, an appearance of an automobile is required to have a luxurious feeling, and a design having a strong metallic tone and a high flip-flop property is preferred. For this reason, the second base coating film is configured to include a luster pigment.

The multilayer coating film is formed mainly on an outer panel part of a vehicle body. No multilayer coating film is often formed on interior panel parts. On an inner panel part, for example, only the first base coating film to be used for coating the outer panel part is formed. Since the coating film finally formed on the inner panel part and that finally formed on the outer panel part are different, a color difference may occur between the inner panel and the outer panel. This color difference causes, for example, streaky coating unevenness in the inner panel part. The streaky coating unevenness is formed by scattering of the second base coating composition also to the inner panel part at the time of applying the first base coating composition for the first base coating film and the second base coating composition for the second base coating film to the outer panel part after coating of the inner panel part. Conventionally, solution of this problem has been carried out using a coating composition dedicated to the inner panel part, but this measure is poor in productivity, resulting in cost increase. When the first base coating film and the second base coating film are formed using the same coating composition, a desired flip-flop property is not obtained.

In this regard, Patent Document 1 discloses a method involving controlling the discharge amount of the second base coating composition and the moving speed of a spray gun.

### PATENT DOCUMENTS

Patent Document 1: JP 2022-126528 A

### SUMMARY

### Problems to be Solved by the Invention

An object of the present disclosure is to provide, in the case of forming the first base coating film using the same first base coating composition for the outer panel part and the inner panel part, a multilayer coating film (corresponding to the outer panel part) with which a small difference in hue from a single film (corresponding to the inner panel part) of the first base coating film and a high flip-flop property is obtained.

### Solutions to the Problems

To solve the problems described above, the present invention provides the following embodiments.

[1]

A multilayer coating film including:
a first base coating film formed from a water-borne first base coating composition on an article to be coated;
a second base coating film formed from a water-borne second base coating composition on the first base coating film; and
a clear coating film formed from a clear coating composition on the second base coating film, wherein
in the water-borne first base coating composition, a luster pigment and two or more coloring pigments are contained,
a solid component concentration NV1 is 20 to 35% by mass,
PWC_{G1} of the luster pigment is 1 to 25%, and
PWC_{C1} of the coloring pigments is 0.1 to 5.0%;
in the water-borne second base coating composition, a luster pigment and two or more coloring pigments each having the same Color Index name as those of the coloring pigments contained in the water-borne first base coating composition are contained,
a solid component concentration NV2 is 7 to 30% by mass,
PWC_{G2} of the luster pigment is 5 to 35%, and
PWC_{C2} of the coloring pigments is 0.5 to 20.0%;
a ratio (T1/T2) of a thickness T1 of the first base coating film to a thickness T2 of the second base coating film is 1.5/1 to 5/1;
a ratio (NV1/NV2) of the solid component concentration NV1 to the solid component concentration NV2 is 1.3/1 to 3/1;
a ratio (PWC_{G1}/PWC_{G2}) of the PWC_{G1} of the luster pigment to the PWC_{G2} of the luster pigment is 1/10 to 1/1; and
a ratio (PWC_{C1}/PWC_{C2}) of the PWC_{C1} of the coloring pigments to the PWC_{C2} of the coloring pigments is 1/5 to 1/1.
   [2]

The multilayer coating film according to [1], wherein
on the basis of a spectral reflectance of light I₄₅ illuminated at an angle of 45 degrees with respect to a surface of a coating film and received at an angle of 25 degrees deviated from specular reflection light, for a lightness L*25 value, and a color difference E*25 value calculated from the lightness L*25 value, an a*25 value, and a b*25 value,
a value ΔL*25 determined by subtracting a lightness Lbc*25 of the first base coating film from a lightness Lm*25 value of the multilayer coating film is 0 to 10, and
a difference ΔE*25 between a color difference Em*25 value of the multilayer coating film and a color difference Ebc*25 of the first base coating film is 10 or less;
on the basis of a spectral reflectance of light I₄₅ illuminated at an angle of 45 degrees with respect to the surface of the coating film and received at an angle of 45 degrees deviated from specular reflection light, for a lightness L*45 value, and a color difference E*45 value calculated from the lightness L*45 value, an a*45 value, and a b*45 value,
a value ΔL*45 determined by subtracting a lightness Lbc*45 of the first base coating film from a lightness Lm*45 value of the multilayer coating film is −10 to 0, and
a difference ΔE*45 between a color difference Em*45 value of the multilayer coating film and a color difference Ebc*45 of the first base coating film is 10 or less.
   [3]

The multilayer coating film according to [1] or [2], wherein a difference between an average particle size of the luster pigment contained in the water-borne first base coating composition and an average particle size of the luster pigment contained in the water-borne second base coating composition is 5 μm or less.

### Effects of the Invention

According to the present disclosure, there is provided a multilayer coating film having a small difference in hue from the first base coating film and having a high flip-flop property.

### BRIEF DESCRIPTION OF THE DRAWINGS

FIG. 1 is a perspective view schematically showing a method for coating a test panel for evaluating dust streaks in Examples.

### DETAILED DESCRIPTION

To reduce the difference in hue between the first base coating film and the multilayer coating film including the first base coating film, the second base coating film, and the clear coating film, two or more coloring pigments are blended in both the water-borne first base coating composition and the water-borne second base coating composition, the two or more coloring pigments in the water-borne first base coating composition each having the same Color Index name of those in the water-borne second base coating composition. Thus, when the first base coating film is formed on the inner panel part using the same first base coating composition as that of the outer panel part, the difference in hue between the outer panel part and the inner panel part is reduced.

The outer panel part is typically a portion that can be seen when the automobile is viewed from the outside. Specifically, the outer panel is a door outer, a roof, a front fender, a side panel outer, a hood, or the like. The inner panel part is typically a portion that cannot be seen when the automobile is viewed from the outside. Specifically, the inner panel part is a door inner, a pillar, a floor, or the like.

As described above, the difference in hue appears as streaky coating unevenness (hereinafter also referred to as a dust streak) formed on the inner panel part of the vehicle body. In a process of coating an automobile body, first, the first base coating composition is applied to the inner panel part. Next, the first base coating composition and the second base coating composition are applied to the outer panel part. The second base coating composition is applied in a state where the door is not completely closed. Therefore, the second base coating composition scatters to a pillar, and dust streaks are formed. Since the difference in hue between the first base coating film and the multilayer coating film of the present disclosure is small, generation of dust streaks is suppressed, so that a finish without incompatibility is obtained.

The Color Index is a database in which synthetic dyes and pigments industrially manufactured and sold are organized and classified on the basis of species, hue, and chemical structure. The Color Index includes a Color Index name (Colour Index Generic Name) classified on the basis of species and hue for each chemical structure, and a Color Index number (Colour Index Constitution Number) classified for each chemical structure. In the present disclosure, a Color Index name is adopted.

The Color Index is published by the British Society of Dyers and Colourists (SDC) and the American Association of Textile Chemists and Colourists (AATCC). Many manufacturing companies indicate color index names together with trade names on products or in catalogs. From these pieces of information, the Color Index name of a pigment can be acquired.

According to “Colour Index™ Online” (https://colour-index.com/colour-index-generic-name) published by SDC and AATCC, in the Color Index name, two or more pigments having the same chemical structure but different crystalline forms are distinguished by attaching a number after a colon (:). For example, copper phthalocyanine blue has a plurality of Color Index names of “P.B 15:1”, “P.B 15:3”, and “P.B 15:6”. These copper phthalocyanine blues have α-type, β-type, and ε-type crystal forms in order.

In the present disclosure, the “coloring pigments having the same Color Index name “means coloring pigments having the same chemical structure (the same symbol before the colon) regardless of the difference in crystal form (that is, even if the number after the colon is different). In the case of the copper phthalocyanine blue described above, a plurality of pigments with the symbol before the colon is “P.B 15” are considered as “coloring pigments having the same Color Index name” even if the number after the colon is different. Hereinafter, “coloring pigments having the same Color Index name” may be referred to as “the same series of color” for convenience.

To achieve a high flip-flop property (FF property) while reducing the difference in hue, furthermore, the thickness ratio of the coating films is controlled, and the pigment weight concentration (PWC) ratios of the coating compositions regarding the coloring pigments and the luster pigment and the solid component mass ratio of the coating compositions are controlled.

The flip-flop property refers to a property in which the brightness of a coating film surface varies depending on the viewing angle. In the present disclosure, the ratio (L*15/L*75) of the lightness L*(L*15, L*75) in the L*a*b* color system (the CIE1976 L*a*b* color space) calculated from the spectral reflectance values of light I₄₅ illuminated at an angle of 45 degrees with respect to a surface of the multilayer coating film and received at an angle of 15 degrees or 75 degrees deviated from specular reflection light is used as an index of the FF property. The larger the ratio (L*15/L*75) is, the better in FF property the multilayer coating film is.

### Ratio of Thickness of Coating Films

The ratio (T1/T2) of the thickness T1 of the first base coating film to the thickness T2 of the second base coating film is 1.5/1 to 5/1. That is, the first base coating film is thicker than the second base coating film. When T1/T2 is within this range, the orientation of the luster pigment is enhanced, so that the flip-flop property is improved. T1/T2 may be 1.5/1 to 3/1.

### Ratio of PWC of Coloring Pigments

The ratio (PWC_{C1}/PWC_{C2}) of the PWC_{C1} of the two or more coloring pigments contained in the water-borne first base coating composition (the these coloring pigments may hereinafter be collectively referred to as the first coloring pigment) to the PWC_{C2} of the coloring pigments contained in the water-borne second base coating composition (these coloring pigments may hereinafter be collectively referred to as the second coloring pigment) is 1/5 to 1/1. When PWC_{C1}/PWC_{C2} is within this range, the difference in hue between the first base coating film and the multilayer coating film is reduced. That is, the generation of dust streaks is suppressed. PWC_{C1}/PWC_{C2} may be 1/3 to 1/1.1, and may be 1/2.5 to 1/1.25.

### Ratio of PWC of Luster Pigments

The ratio (PWC_{G1}/PWC_{G2}) of PWC_{G1} of the luster pigment contained in the water-borne first base coating composition (this luster pigment may hereinafter be referred to as the first luster pigment) to PWC_{G2} of the luster pigment contained in the water-borne second base coating composition (this luster pigment may hereinafter be referred to as the second luster pigment) is 1/10 to 1/1. When PWC_{G1}/PWC_{G2} is within this range, the orientation of the luster pigments is enhanced, so that the flip-flop property is improved. PWC_{G1}/PWC_{G2} may be 1/5 to 1/1.1, and may be 1/3 to 1/1.25.

### Ratio of Solid Component Mass

The ratio (NV1/NV2) of the solid component concentration NV1 of the water-borne first base coating composition to the solid component concentration NV2 of the water-borne second base coating composition is 1.3/1 to 3/1. That is, the solid component of the water-borne first base coating composition is more than the solid component of the water-borne second base coating composition. When NV1/NV2 is within this range, the orientation of the luster pigments is enhanced, so that the flip-flop property is improved. NV1/NV2 may be 1.3/1 to 2.5/1.

### Lightness Difference and Color Difference Between First Base Coating Film and Multilayer Coating Film

When both the lightness difference and the color difference between the first base coating film and the multilayer coating film are within prescribed ranges, it can be said that the difference in hue between the first base coating film and the multilayer coating film is small.

The lightness and the color difference are the lightness L* and the color difference E* in the L*a*b* color system (the CIE1976 L*a*b* color space) calculated from the spectral reflectance of light I₄₅ illuminated at an angle of 45 degrees with respect to a surface of a coating film and received at a prescribed angle deviated from specular reflection light. The color difference E* value is calculated from the lightness L* value, the a* value, and the b* value by the following formula.

$$Color difference {E}^{*} = √ \{ {( {L}^{*} )}^{2} + {( {a}^{*} )}^{2} + {( {b}^{*} )}^{2} \}$$

A value ΔL*25 obtained by subtracting a value of Lbc*25 based on a spectral reflectance of light I₄₅ illuminated to a surface of the first base coating film and received at an angle of 25 degrees deviated from specular reflection light from a value of Lm*25 based on a spectral reflectance of light I₄₅ illuminated to a surface of the multilayer coating film and received at an angle of 25 degrees deviated from specular reflection light is 0 to 10. ΔL*25 may be 0 to 6.

A value ΔL*45 obtained by subtracting a value of Lbc*45 based on a spectral reflectance of light I₄₅ illuminated to a surface of the first base coating film and received at an angle of 45 degrees deviated from specular reflection light from a value of Lm*45 based on a spectral reflectance of light I₄₅ illuminated to a surface of the multilayer coating film and received at an angle of 45 degrees deviated from specular reflection light is −10 to 0. ΔL*45 may be −6 to 0.

A difference ΔE*25 between the color difference Em*25 value of the multilayer coating film calculated from the Lm*25 value by the above formula and the color difference Ebc*25 value of the first base coating film calculated from the Lbc*25 value by the above formula is 10.0 or less. ΔE*25 may be 6.0 or less.

A difference ΔE*45 between the color difference Em*45 value of the multilayer coating film calculated from the Lm*45 value by the above formula and the color difference Ebc*45 value of the first base coating film calculated from the Lbc*45 value by the above formula is 10.0 or less. ΔE*45 may be 6.0 or less.

The fact that ΔL*25 is 0 to 10 and ΔL*45 is −10 to 0 means that the lightness difference is very small. The fact that ΔE*25 is 10 or less and ΔE*45 is 10 or less means that the difference in color difference is very small. Thanks to the fact that the difference in lightness and the difference in color difference between the multilayer coating film and the first base coating film are small, it can be felt that the difference in hue is small.

The lightness L* and the color difference E* can be obtained using a multiangle spectrophotometer (for example, trade name “BYK-mac i” manufactured by BYK). The lightness L* and the color difference E* are average values of five different samples or arbitrary five points of the same sample.

The lightness L* and the color difference E* of a water-borne first base coating film are measured using a coating film formed under the same conditions as those for forming the first base coating film and the clear coating film that constitute the multilayer coating film on the same article to be coated as the article to be coated on which the multilayer coating film is formed.

The lightness L* and the color difference E* of the water-borne first base coating film and the multilayer coating film respectively correspond to the lightness and the color difference of an inner panel part and an outer panel part of a vehicle body. The lightness and the color difference of the inner panel part (typically a pillar) and the outer panel part (typically a door outer) of the vehicle body may be regarded as the lightness L* and the color difference E* of the water-borne first base coating film and the multilayer coating film.

When ΔL*25 is 0 to 10, ΔL*45 is −10 to 0, ΔE*25 is 10.0 or less, and ΔE*45 is 10.0 or less with regard to the lightness and the color difference of the inner panel part and the outer panel part of the vehicle body, there is a high possibility that the inner panel part and the outer panel part are formed of the water-borne first base coating composition and the water-borne second base coating composition used in the present disclosure. The lightness of the inner panel part and the outer panel part of the vehicle body is an average value of arbitrary five points of the inner panel part and arbitrary five points of the outer panel part of the same vehicle body.

In this specification, the glass transition temperature (Tg) of a resin can be determined by calculation from the type and the amount of the starting monomers used for the preparation of the resin. The Tg may be measured with a differential scanning calorimeter (DSC).

The number-average molecular weight (Mn) and the weight-average molecular weight (Mw) can be measured by gel permeation chromatography (GPC) using a polystyrene standard sample after removing moisture by reduced pressure drying or the like.

The hydroxyl value (OHV) and the acid value (AV) are determined on the basis on the solid component mass. The hydroxyl value (OHV) and the acid value (AV) can be measured by the publicly known method described in JIS K 0070: 1992. The hydroxyl value (OHV) and the acid value (AV) may be calculated from the blending amount of the unsaturated monomer in the starting monomer of the target resin.

The solid component is also referred to as a non-volatile matter. Specifically, the solid component of the coating composition is all components of the coating composition excluding the solvent. The solid component concentration is determined by dividing the total mass of the solid components excluding the solvent from the coating composition by the mass of the entire coating composition. The solid component concentration can also be calculated from the residue yielded when the coating composition is heated at 140° C. in accordance with the determination of non-volatile matter content specified in JIS K 5601-1-2. The solid component of the water-borne coating composition specifically includes an aqueous resin, a curing agent, a luster pigment, a coloring pigment, and other solid components added as necessary, which will be described later.

The resin solid component is a resin component among the solid components. The solid component of the water-borne coating composition specifically includes an aqueous resin, a curing agent, and other resins, which will be described later.

The PWC (% by mass) of a pigment (for example, a luster pigment) is calculated by dividing the mass of the target pigment by the total mass of all the pigments and the resin solid component contained in the coating composition (see the following equation). The target pigment may include a plurality of types of pigments. For example, the PWC_{C1} of the first coloring pigment is calculated from the total mass of the plurality of types of coloring pigments contained in the water-borne first base coating composition.

$$PWC ( \% by mass ) of the target pigment = 100 \times ( mass of the target pigment ) / ( total mass of all pigments + resin solid component mass )$$

The thickness of a coating film can be measured with an electro-magnetic coating thickness meter (for example, SDM-miniR manufactured by SANKO). The thickness of a coating film is an average value of the thicknesses of the coating film at arbitrary five points.

The average particle size is a 50% average particle size (D50) in a volume-based particle size distribution determined using a laser diffraction/scattering type particle size distribution analyzer. Examples of the particle size distribution analyzer include UPA-150 (Microtrac particle size distribution analyzer manufactured by Nikkiso Co., Ltd.).

Aqueous resins are generally roughly classified into water-soluble resins and water-dispersible resins. The water-dispersible resins are further divided into colloidal dispersion type resins and emulsion type resins. A colloidal dispersion type (hereinafter simply referred to as dispersion type) aqueous resin is typically obtained by semi-dissolving a resin synthesized in an organic solvent (a solution-polymerized resin) in water with a neutralizing agent. The emulsion type aqueous resin is typically produced by emulsion polymerization or by mechanical forced emulsification.

In the case of an aqueous acrylic resin, an aqueous acrylic resin having an Mw of more than 100,000 can be regarded as an emulsion type, and an aqueous acrylic resin having an Mw of 100,000 or less can be regarded as a colloidal dispersion type. If the Mw exceeds 1,000.000, it becomes difficult to measure the Mw. An aqueous acrylic resin whose Mw cannot be measured may be regarded as an emulsion type. The aqueous resin includes a water-soluble resin, a dispersion type resin, and an emulsion type resin.

### [Multilayer Coating Film]

The multilayer coating film includes a first base coating film formed on an article to be coated from a water-borne first base coating composition, a second base coating film formed on the first base coating film from a water-borne second base coating composition, and a clear coating film formed on the second base coating film from a clear coating composition.

The lightness Lm*25 of the multilayer coating film is, for example, 35 or more and 110 or less. The lightness Lm*25 may be 40 or more, may be 45 or more, and may be 55 or more. The lightness Lm*25 is 100 or less, may be 95 or less, and may be 90 or less.

The lightness Lm*45 of the multilayer coating film is, for example, 10 or more and 60 or less. The lightness Lm*45 may be 15 or more, may be 20 or more, may be 25 or more, and may be 30 or more. The lightness Lm*45 may be 50 or less, may be 45 or less, and may be 40 or less.

### Water-Borne First Base Coating Film

The dry thickness of the water-borne first base coating film is, for example, 5 to 15 μm. The dry thickness of the water-borne second base coating film is, for example, 2 to 8 μm. The dry thickness of the clear coating film is, for example, 10 to 60 μm.

The lightness Lbc*25 of the water-borne first base coating film is, for example, 30 or more and 100 or less. The lightness Lbc*25 may be 40 or more, may be 45 or more, and may be 50 or more. The lightness Lbc*25 may be 90 or less, may be 80 or less, and may be 65 or less.

The lightness Lbc*45 of the water-borne first base coating film is, for example, 10 or more and 60 or less. The lightness Lbc*45 may be 20 or more, and may be 30 or more. The lightness Lbc*45 may be 55 or less, may be 50 or less, and may be 40 or less.

### Water-Borne First Base Coating Composition

The water-borne first base coating composition includes, for example, an aqueous resin, a curing agent, a luster pigment, and a coloring pigment.

The solid component concentration NV1 of the water-borne first base coating composition is 20 to 35% by mass. When the solid component concentration NV1 is 20% by mass or more, the coating efficiency is improved. When the solid component concentration NV1 is 35% by mass or less, the appearance is improved. The solid component concentration NV1 may be 25% by mass or more. The solid component concentration NV1 may be 30% by mass or less.

### (Aqueous Resin)

Examples of the aqueous resin include aqueous acrylic resins, aqueous polyester resins, polyether polyols, and aqueous polyurethane resins. These are used singly or two or more of them are used in combination.

The ratio of the aqueous resin to the resin solid component mass of the water-borne first base coating composition is, for example, 50 to 90% by mass. This makes it easy to achieve both the storage stability and the curability of the water-borne first base coating composition. The ratio of the aqueous resin may be 60% by mass or more. The ratio of the aqueous resin may be 85% by mass or less.

### Aqueous Acrylic Resin

The aqueous acrylic resin may be an emulsion type acrylic resin. The emulsion type acrylic resin (acrylic resin emulsion) has a hydroxy group and a carboxy group. The hydroxy group of the acrylic resin emulsion reacts with the curing agent to form a crosslinked structure.

The Mw of the acrylic resin emulsion is 100,000 or more. The Mw of the acrylic resin emulsion may be 200,000 or more. The upper limit of the Mw of the acrylic resin emulsion is not limited.

The OHV of the acrylic resin emulsion is, for example, 10 mg KOH/g or more and 100 mg KOH/g or less. As a result, the crosslinking density is increased and the chipping resistance is further improved. The OHV of the acrylic resin emulsion may be 20 mg KOH/g or more, and may be 30 mg KOH/g or more. The OHV of the acrylic resin emulsion may be 90 mg KOH/g or less, and may be 80 mg KOH/g or less.

The acid value (AV) of the acrylic resin emulsion is, for example, 5 mg KOH/g or more and 50 mg KOH/g or less. The AV of the acrylic resin emulsion may be 10 mg KOH/g or more, and may be 15 mg KOH/g or more. The AV of the acrylic resin emulsion may be 40 mg KOH/g or less, and may be 30 mg KOH/g or less.

The Tg of the acrylic resin emulsion is, for example, −15° C. or more and 60° C. or less. As a result, the Tg of the first base coating film tends to be 60° C. or more. The Tg of the acrylic resin emulsion may be −10° C. or more, and may be 25° C. or more. The Tg of the acrylic resin emulsion may be 55° C. or less, and may be 50° C. or less.

The average particle size of the acrylic resin emulsion is, for example, 20 nm or more and 200 nm or less. The average particle size of the acrylic resin emulsion may be 180 nm or less, may be 160 nm or less, may be 150 nm or less, and may be 100 nm or less. The average particle size of the acrylic resin emulsion may be 25 nm or more, and may be 30 nm or more.

The solid component content of the acrylic resin emulsion is 8 parts by mass or more and 20 parts by mass or less per 100 parts by mass of the resin solid component of the water-borne first base coating composition. The aforementioned content of the acrylic resin emulsion may be 10 parts by mass or more. The aforementioned content of the acrylic resin emulsion may be 15 parts by mass or less, and may be 12 parts by mass or less.

Such acrylic resin emulsions are used singly or two or more of them are used in combination. When a plurality of kinds of aqueous acrylic resin is contained, the OHV, AV, and Tg of the aqueous acrylic resin are average values calculated based on the OHV, AV, and Tg and the mass ratio of each kind of aqueous acrylic resin.

The aqueous acrylic resin is obtained, for example, by copolymerizing monomers including an α,β-ethylenically unsaturated monomer having a hydroxy group and an α,β-ethylenically unsaturated monomer having a carboxy group.

Examples of the α,β-ethylenically unsaturated monomer having a hydroxy group include 2-hydroxyethyl (meth)acrylate, 2-hydroxypropyl (meth)acrylate, 4-hydroxybutyl (meth)acrylate, allyl alcohol, methacryl alcohol, and an adduct of hydroxyethyl (meth)acrylate and ε-caprolactone. The α,β-ethylenically unsaturated monomer having a hydroxy group may be 2-hydroxyethyl (meth)acrylate, 4-hydroxybutyl (meth)acrylate, or an adduct of hydroxyethyl (meth)acrylate and F-caprolactone.

(Meth)acrylic acid includes both acrylic acid and methacrylic acid.

Examples of the α,β-ethylenically unsaturated monomer having a carboxy group include acrylic acid, methacrylic acid, acrylic acid dimer, crotonic acid, 2-acryloyloxyethylphthalic acid, 2-acryloyloxyethylsuccinic acid, ω-carboxy-polycaprolactone mono(meth)acrylate, maleic acid, fumaric acid, and itaconic acid. The α,β-ethylenically unsaturated monomer having a carboxy group may be acrylic acid or methacrylic acid.

Other α,β-ethylenically unsaturated monomers may be used as a copolymerization component. Examples of such other α,β-ethylenically unsaturated monomers include (meth)acrylic acid esters, such as methyl (meth)acrylate, ethyl (meth)acrylate, n-propyl (meth)acrylate, n-butyl (meth)acrylate, isobutyl (meth)acrylate, tert-butyl (meth)acrylate, 2-ethylhexyl (meth)acrylate, lauryl methacrylate, phenyl acrylate, isobornyl (meth)acrylate, cyclohexyl methacrylate, tert-butylcyclohexyl (meth)acrylate, dicyclopentadienyl (meth)acrylate, and dihydrodicyclopentadienyl (meth)acrylate, and polymerizable amide compounds, such as (meth)acrylamide, N-methylol(meth)acrylamide, and N-butoxymethyl(meth)acrylamide.

The other α,β-ethylenically unsaturated monomers may be crosslinkable monomers. The crosslinkable monomers have two or more radically polymerizable, ethylenically unsaturated groups in a molecule. Examples the crosslinkable monomer include divinylbenzene, allyl (meth)acrylate, and ethylene glycol di(meth)acrylate.

The acrylic resin emulsion is typically synthesized by emulsion polymerization. The method of emulsion polymerization is not particularly limited. For example, an emulsifier is dissolved in water or an aqueous medium containing an organic solvent such as an alcohol or an ether (for example, dipropylene glycol methyl ether or propylene glycol methyl ether) as necessary, and the starting monomers described above and a polymerization initiator are added dropwise under heating and stirring. The starting monomers may be emulsified in advance with an emulsifier.

Examples of the polymerization initiator include lipophilic azo compounds such as azobisisobutyronitrile, 2,2′-azobis(2-methylbutyronitrile), and 2,2′-azobis(2,4-dimethylvaleronitrile); hydrophilic compounds such as 4,4′-azobis(4-cyanovaleric acid) and 2,2-azobis(N-(2-carboxyethyl)-2-methylpropionamidine, which are anionic, and 2,2′-azobis(2-methylpropionamidine), which is cationic; redox-type lipophilic peroxides such as benzoyl peroxide, parachlorobenzoyl peroxide, lauroyl peroxide, and t-butyl perbenzoate; and hydrophilic peroxides such as potassium persulfate and ammonium persulfate.

The emulsifier is not particularly limited. Examples of the emulsifier include reactive emulsifiers. Examples of the reactive emulsifier include Antox MS-60 (manufactured by Nippon Nyukazai Co., Ltd.), ELEMINOL JS-2 (manufactured by Sanyo Chemical Industries, Ltd.), ADEKA REASOAP NE-20 (manufactured by ADEKA Corporation), AQUALON HS-10 (manufactured by DKS Co. Ltd.), and LATEMUL PD-104 (manufactured by Kao Corporation). A chain transfer agent such as a mercaptan (for example, lauryl mercaptan) and α-methylstyrene dimer may be used to adjust the molecular weight.

The reaction temperature is determined according to the polymerization initiator. For example, when an azo initiator or a peroxide is used, the reaction temperature is 60 to 90° C. When a redox initiator is used, the reaction temperature is 30 to 70° C. The reaction time is 1 to 8 hours. The amount of the polymerization initiator per 100 parts by mass of a monomer mixture is 0.1 to 5 parts by mass. The emulsion polymerization may be performed in multiple steps, for example, in two steps. In the two-step polymerization, a part of the starting monomer is subjected to emulsion polymerization, and then the remaining starting monomer is polymerized.

The acrylic resin emulsion may be neutralized with a basic compound from the viewpoint of storage stability. The acrylic resin emulsion is held at pH 5 to 10. The neutralization is carried out before or after the emulsion polymerization.

The basic compound is not particularly limited, and examples thereof include at least one compound selected from the group consisting of ammonia and amine compounds. Examples of the amine compound include dimethylamine, trimethylamine, ethylamine, diethylamine, triethylamine, n-propylamine, isopropylamine, triallylamine, triethylenediamine, N,N-dimethylethanolamine, N,N-diethylethanolamine, aminoethanolamine, N-methyl-N,N-diethanolamine, iminobispropylamine, 3-ethoxypropylamine, 3-diethylaminopropylamine, methylaminopropylamine, methyliminobispropylamine, 3-methoxypropylamine, monoethanolamine, diethanolamine, triethanolamine, morpholine, allylmorpholine, N-methylmorpholine, and N-ethylmorpholine. These are used singly or two or more of them are used in combination.

The acrylic resin emulsion can also be obtained by solution polymerization and neutralization. The solution polymerization is performed by a publicly known method.

A water-soluble acrylic resin can be prepared, for example, by solution-polymerizing the α,β-ethylenically unsaturated monomer described above and solubilizing the resultant in water using a basic compound.

### Aqueous Polyester Resin

The aqueous polyester resin may be a dispersion type. The aqueous polyester resin may have a hydroxy group and a carboxy group.

The OHV of the aqueous polyester resin is, for example, 50 to 150 mg KOH/g. The OHV may be 70 mg KOH/g or more. The OHV may be 120 mg KOH/g or less, and may be 100 mg KOH/g or less.

The AV of the aqueous polyester resin is, for example, 20 to 80 mg KOH/g. The AV may be 25 mg KOH/g or more. The AV may be 50 mg KOH/g or less, and may be 40 mg KOH/g or less.

The Mn of the aqueous polyester resin is, for example, 500 to 20,000. When the Mn of the aqueous polyester resin is 500 or more, the storage stability is improved. When the Mn of the aqueous polyester resin is 20,000 or less, an increase in viscosity is suppressed, and coating workability is improved. The Mn of the aqueous polyester resin may be 1,500 or more. The Mn of the aqueous polyester resin may be 10,000 or less.

The Tg of the aqueous polyester resin is, for example, −20 to 80° C. When the Tg of the aqueous polyester resin is −20° C. or more, the hardness of a resulting coating film increases. When the Tg of the aqueous polyester resin is 80° C. or less, the performance of hiding a substrate (hiding property) is improved. The Tg of the aqueous polyester resin may be 0° C. or more. The Tg of the aqueous polyester resin may be 60° C. or less.

The aqueous polyester resin is obtained by neutralizing a polyester resin with a basic compound. The polyester resin is produced, for example, via condensation of a polyhydric alcohol component and a polybasic acid component.

Examples of the polyhydric alcohol component may include hydroxycarboxylic acid components such as ethylene glycol, diethylene glycol, propylene glycol, 1,3-propanediol, 1,4-butanediol, 1,5-pentanediol, 1,6-hexanediol, 2,2-diethyl-1,3-propanediol, neopentyl glycol, 1,9-nonanediol, 1,4-cyclohexanediol, neopentyl glycol hydroxypivalate ester, 2-butyl-2-ethyl-1,3-propanediol, 3-methyl-1,5-pentanediol, and 2,2,4-trimethylpentanediol. These are used singly or two or more of them are used in combination.

Examples of the polybasic acid component include aromatic polycarboxylic acids and anhydrides thereof such as phthalic anhydride, isophthalic acid, terephthalic acid, trimellitic anhydride, tetrachlorophthalic anhydride, and pyromellitic anhydride; alicyclic polycarboxylic acids and anhydrides thereof such as hexahydrophthalic anhydride, tetrahydrophthalic anhydride, and 1,4- and 1,3-cyclohexanedicarboxylic acids; aliphatic polycarboxylic acids and anhydrides thereof such as maleic anhydride, fumaric acid, succinic anhydride, adipic acid, and sebacic acid. These are used singly or two or more of them are used in combination.

A monobasic acid such as benzoic acid and tert-butylbenzoic acid may be used together, as necessary.

Monohydric alcohols, monoepoxide compounds such as CARDURA E (trade name, manufactured by Oxalis Chemicals Ltd.), and lactones (β-propiolactone, dimethylpropiolactone, butyrolactone, γ-valerolactone, ε-caprolactone, γ-caprolactone, etc.) may be used together as reaction components. These are used singly or two or more of them are used in combination.

Furthermore, fatty acids such as castor oil and dehydrated castor oil, and one or a mixture of two or more of these fatty acids may be added to the reaction system.

The polyester resin may be grafted with an aqueous acrylic resin and/or a vinyl resin, and may be reacted with a polyisocyanate compound.

### Polyether Polyol

The polyether polyol is a resin other than those described above, and has two or more hydroxy groups in one molecule. The polyether polyol may have three or more hydroxy groups per molecule on average. As a result, coating film strength can be further increased. The polyether polyol may be an emulsion type or may be soluble in water.

The Mn of the polyether polyol is, for example, 300 to 2000. When the Mn of the polyether polyol is 300 or more, the coating film performance is improved. When the Mn of the polyether polyol is 2000 or less, the coating film appearance is improved. The Mn of the polyether polyol may be 400 or more, and may be 500 or more. The Mn of the polyether polyol may be 1800 or less, and may be 1500 or less.

The polyether polyol is obtained, for example, by addition polymerization of an alkylene oxide such as ethylene oxide, propylene oxide, or tetrahydrofuran to a polyhydric alcohol. The polyether polyol may be a polyether diol having two hydroxy groups in one molecule.

Examples of the polyether diol include polyalkylene glycols such as polyethylene glycol, polypropylene glycol, polyethylene propylene glycol, polytetramethylene ether glycol, polyhexamethylene ether glycol, and polyoctamethylene ether glycol.

Examples of the polyether polyol include polyethylene glycol, polypropylene glycol, polytetramethylene glycol, and block bodies thereof. The polyether polyol is obtained by adding ethylene oxide and/or propylene oxide to a polyhydric alcohol compound.

Examples of commercially available products of the polyether polyol include the SANNIX series manufactured by Sanyo Chemical Industries, Ltd. Specifically, SANNIX GP-250, SANNIX GP-400, SANNIX PP-200, and SANNIX GP-600 are included.

### Aqueous Polyurethane Resin

The aqueous polyurethane resin may be soluble in water or may be dispersible in water. The aqueous polyurethane resin may be a dispersion type. The aqueous polyurethane resin is used singly, or two or more aqueous polyurethane resins are used in combination.

The aqueous polyurethane resin is fused with itself and other components to make the coating film tough, and also enhances the impact absorbability of the coating film. The aqueous polyurethane resin improves the chipping resistance and adhesion of a multilayer coating film.

The OHV of the aqueous polyurethane resin is, for example, 0 mg KOH/g or more and 50 mg KOH/g or less. As a result, coating film strength is improved. The OHV of the aqueous polyurethane resin may be 5 mg KOH/g or more, and may be 10 mg KOH/g or more. The OHV of the aqueous polyurethane resin may be 40 mg KOH/g or less, and may be 30 mg KOH/g or less.

The AV of the aqueous polyurethane resin is, for example, 0 mg KOH/g or more and 20 mg KOH/g or less. As a result, water resistance is improved. The OHV of the aqueous polyurethane resin may be 5 mg KOH/g or more, and may be 10 mg KOH/g or more. The AV of the aqueous polyurethane resin may be 17 mg KOH/g or less, and may be 15 mg KOH/g or less.

The Tg of the aqueous polyurethane resin is, for example, −20° C. or less. When the Tg is −20° C. or less, chipping resistance is further improved. The Tg of the aqueous polyurethane resin may be −30° C. or less, and may be −50° C. or less. The lower limit of the Tg of the aqueous polyurethane resin is not particularly limited. The Tg of the aqueous polyurethane resin may be, for example, −90° C. or more.

The weight-average molecular weight (Mw) of the aqueous polyurethane resin is, for example, 20,000 or more. As a result, the strength of the coating film is increased, and adhesion is improved. The Mw of the aqueous polyurethane resin may be 150,000 or more, and may be 250,000 or more. The upper limit of the Mw of the aqueous polyurethane resin is not particularly limited. The Mw of the aqueous polyurethane resin may be, for example, 1,000,000 or less.

The aqueous polyurethane resin is obtained, for example, by a method of forcibly emulsifying a polyurethane resin using a surfactant, or a method of neutralizing a polyurethane resin with a base or an acid.

The polyurethane resin is obtained by, for example, a reaction of a polyol, a compound having an active hydrogen group and a hydrophilic group in the molecule, a polyisocyanate compound described later, and, as necessary, a chain extender and a polymerization terminator. As necessary, a chain extender and a polymerization terminator may be used.

Examples of the polyol include polyester polyol, polyether polyol, polycarbonate polyol, polyacrylate polyol, and polyhydric alcohols. These are used singly or two or more of them are used in combination. Among them, the polyol may be a polyether polyol.

Examples of the compound having an active hydrogen group and a hydrophilic group in the molecule include a compound containing active hydrogen and an anionic group, a cationic group, or a nonionic hydrophilic group. The anion group includes an anion group and an anion forming group. The anion forming group is a group capable of reacting with a base to form an anion group, and specifically, an anion group is formed from the anion forming group via neutralization with a base before, during, or after the urethanization reaction.

Examples of the compound containing active hydrogen and an anion group are described in JP S42-24192 B and JP S55-41607 B, and specific examples thereof include α,α-dimethylolpropionic acid and α,α-dimethylolbutyric acid. The compound having active hydrogen and a cationic group is described in, for example, JP S43-9076 B. Examples of the compound having active hydrogen and a nonionic hydrophilic group are described in JP S48-41718 B, and specific examples thereof include polyethylene glycol and an alkyl alcohol alkylene oxide adduct.

### (Curing Agent)

Examples of the curing agent include a blocked isocyanate compound, a melamine resin, an epoxy compound, an aziridine compound, a carbodiimide compound, an oxazoline compound, and a metal ion. These are used singly or two or more of them are used in combination. The curing agent may be a melamine resin, a blocked isocyanate compound, or a carbodiimide compound, and may be a melamine resin.

The ratio of the crosslinking agent to the resin solid component mass of the water-borne first base coating composition is, for example, 10 to 50% by mass. The ratio of the crosslinking agent may be 15% by mass or more. The ratio of the crosslinking agent may be 40% by mass or less.

### Melamine Resin

The melamine resin has a structure in which six substituents R¹ to R⁶ are bonded to the periphery of a triazine ring (triazine nucleus) via three nitrogen atoms N¹ to N³ (—N¹(R¹)(R²), —N²(R³)(R⁴), —N³(R⁵)(R⁶)).

The melamine resin is represented, for example, by the following general formula (1):

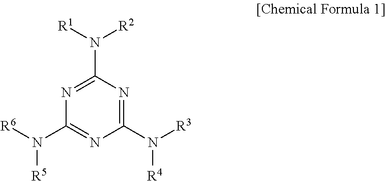

wherein the substituents R¹ to R⁶ each independently represent a hydrogen atom, an alkyl ether group, a methylol group, or a bonding moiety with another triazine ring.

The number of the carbon atoms of the alkyl group (R⁷) constituting the alkyl ether (—CH₂—OR⁷) may be 1 to 8, and may be 1 to 4. R⁷ may be linear or may be branched. R⁷ may be a methyl group, an ethyl group, a propyl group, or a butyl group.

The melamine resin may be composed of a polynuclear body in which a plurality of triazine rings are bonded, or may be a mononuclear body composed of one triazine ring.

Examples of the melamine resin include a methylol group type having —N(—CH₂—OR⁷)(—CH₂OH); an imino group type having —N(—CH₂—OR⁷)(H); a methylol/imino group type having —N(—CH₂—OR⁷)(—CH₂OH) and —N(—CH₂—OR⁷)(H), and a full alkyl type having only an alkyl ether group as the substituents R¹ to R⁶.

The Mw of the melamine resin may be 400 or more and 2000 or less. As a result, the viscosity of the water-borne first base coating composition is suppressed to be low, and the coating film appearance is improved. The Mw of the melamine resin may be 1500 or less, and may be 1300 or less. The Mw of the melamine resin may be 500 or more, and may be 600 or more.

### Blocked Isocyanate Compound

The blocked isocyanate compound can be prepared by blocking a polyisocyanate compound with a blocking agent.

The polyisocyanate compound has at least two isocyanate groups in one molecule. Examples of the polyisocyanate compound include aliphatic polyisocyanates, alicyclic polyisocyanates, aliphatic polyisocyanates having an aromatic ring not bonded to an isocyanate group in the molecule (araliphatic polyisocyanates), aromatic polyisocyanates, and derivatives of these polyisocyanates. The examples specifically include aromatic polyisocyanates such as tolylene diisocyanate, 4,4′-diphenylmethane diisocyanate, xylylene diisocyanate, and metaxylylene diisocyanate; aliphatic polyisocyanates such as hexamethylene diisocyanate; alicyclic polyisocyanates such as isophorone diisocyanate; and multimers thereof such as biuret type multimers, nurate type multimers, and adduct type multimers. These are used singly or two or more of them are used in combination.

Examples of the blocking agent include monohydric alkyl (or aromatic) alcohols such as n-butanol, n-hexyl alcohol, 2-ethylhexanol, lauryl alcohol, phenol carbinol, and methylphenyl carbinol; cellosolves such as ethylene glycol monohexyl ether and ethylene glycol mono-2-ethylhexyl ether; polyether-type both-ended diols such as polyethylene glycol, polypropylene glycol, and polytetramethylene ether glycol phenol; polyester-type both-ended polyols obtained from a diol such as ethylene glycol, propylene glycol, or 1,4-butanediol and a dicarboxylic acid such as oxalic acid, succinic acid, adipic acid, suberic acid, or sebacic acid; phenols such as para-t-butylphenol and cresol; oximes such as dimethyl ketoxime, methyl ethyl ketoxime, methyl isobutyl ketoxime, methyl amyl ketoxime, and cyclohexanone oxime; and lactams typified by ε-caprolactam and γ-butyrolactam. As the blocking agent, methyl diketone, methyl ketoester, and methyl diester compounds, which are active hydrogen compounds, for example, alkyl esters such as acetylacetone, ethyl acetoacetate, and diethyl malonate may be used. In addition, a blocked isocyanate prepared using a pyrazole compound or an imidazole compound as a blocking agent may be used.

The blocking ratio of the blocked isocyanate compound is preferably 100%. As a result, the storage stability of the first base coating composition is enhanced.

### Carbodiimide Compound

The carbodiimide compound has at least two carbodiimide groups (—N═C═N—) in the molecule.

Examples of the carbodiimide compound include poly(4,4′-diphenylmethanecarbodiimide), poly(3,3′-dimethyl-4,4′-biphenylmethanecarbodiimide), poly(tolylcarbodiimide), poly(p-phenylenecarbodiimide), poly(m-phenylenecarbodiimide), poly(3,3′-dimethyl-4,4′-diphenylmethanecarbodiimide), poly(naphthylene carbodiimide), poly(1,6-hexamethylene carbodiimide), poly(4,4′-methylenebiscyclohexylcarbodiimide), poly(1,4-tetramethylenecarbodiimide), poly(1,3-cyclohexylenecarbodiimide), poly(1,4-cyclohexylenecarbodiimide), poly(1,3-diisopropylphenylenecarbodiimide), and, poly(1-methyl-3,5-diisopropylphenylenecarbodiimide), poly(1,3,5-triethylphenylenecarbodiimide), and poly(triisopropylphenylenecarbodiimide).

### (First Luster Pigment)

The first luster pigment is not particularly limited. The first luster pigment is, for example, at least one pigment selected from the group consisting of an aluminum flake pigment, a metal oxide-coated alumina flake pigment, a metal oxide-coated silica flake pigment, a graphite pigment, an interference mica pigment, a colored mica pigment, a metal titanium flake pigment, a stainless steel flake pigment, a plate-like iron oxide pigment, a metal-plated glass flake pigment, a metal oxide-coated plated glass flake pigment, a hologram pigment, and a flaky pigment made of a cholesteric liquid crystal polymer.

The PWC_{G1} of the first luster pigment is 1 to 25%. When the PWC_{G1} is 1% or more, a sufficient hiding property is obtained. When the PWC_{G1} is 25% or less, good coating film properties are obtained. The PWC_{G1} may be 2.0% or more, and may be 5.0% or more. The PWC_{G1} may be 2.0% or less, may be 15.0% or less, and may be 10.0% or less.

The average particle size of the first luster pigment is not particularly limited. The average particle size of the first luster pigment may be, for example, 8 to 25 μm in that a sparkle texture is easily improved.

### (First Coloring Pigment)

The first coloring pigment includes two or more coloring pigments of the same series of color as the second coloring pigments. That is, the water-borne first base coating composition contains at least a coloring pigment X′ of the same series of color as the coloring pigment X contained in the water-borne second base coating composition and a coloring pigment Y′ of the same series of color as the coloring pigment Y (being not of the same series of color as the coloring pigment X) contained in the water-borne second base coating composition. Thus, the difference in hue between the multilayer coating film (corresponding to the outer panel part) and the first base coating film (corresponding to the inner panel part) is reduced. Three or more coloring pigments of the same series of color may be contained.

The first coloring pigment is not particularly limited. Examples of the first coloring pigment include organic pigments such as azo lake pigments, insoluble azo pigments, condensed azo pigments, phthalocyanine-based pigments, indigo-based pigments, perinone-based pigments, perylene-based pigments, phthalone-based pigments, dioxazine-based pigments, quinacridone-based pigments, isoindolinone-based pigments, benzimidazolone-based pigments, and diketopyrrolopyrrole-based pigments, and metal complex pigments; and inorganic pigments such as yellow iron oxide, red iron oxide, carbon black, and titanium dioxide. Two or more of them are used in combination.

The PWC_{C1} of the first coloring pigment is 0.1 to 5.0%. When the PWC_{C1} is 0.1% or more, the hue of the first base coating film is easily adjusted, and the color difference from the multilayer coating film tends to be small. When the PWC_{C1} is 5.0% or less, the flip-flop property of the first base coating film can be improved. The PWC_{C1} may be 0.3% or more, and may be 0.5% or more. The PWC_{C1} may be 4.0% or less, and may be 3.0% or less.

### (Extender Pigment)

The water-borne first base coating composition may contain an extender pigment. Examples of the extender pigment include talc, calcium carbonate, precipitated barium sulfate, and silica. The PWC of the extender pigment is not particularly limited.

### (Solvent)

The water-borne first base coating composition contains water as a solvent. The water-borne first base coating composition may contain an organic solvent together with an aqueous solvent. In the water-borne first base coating composition, the proportion of water accounting for in the solvent is, for example, 50% by mass or more, 70% by mass or more, or 90% by mass or more.

Examples of the organic solvent include hydrocarbons such as toluene and xylene, ketones such as acetone and methyl ethyl ketone, esters such as ethyl acetate, butyl acetate, cellosolve acetate, and butyl cellosolve, and alcohols. Among them, a hydrophilic organic solvent typified by alcohols may be used.

Examples of the hydrophilic organic solvent include methyl alcohol, ethyl alcohol, n-propyl alcohol, isopropyl alcohol, secondary butyl alcohol, tertiary butyl alcohol, ethylene glycol, 1,2-propylene glycol, 1,3-butylene glycol, 2,3-butylene glycol, hexylene glycol, 2,5-hexanediol, and dipropylene glycol.

### (Others)

The water-borne first base coating composition may further contain an additive. Examples of the additive include a sedimentation inhibitor, a curing catalyst, an ultraviolet absorber, an antioxidant, a leveling agent, a surface conditioning agent such as silicone or an organic polymer, an anti-sagging agent, a viscosity control agent, an antifoaming agent, a pigment dispersant, a lubricant, and crosslinkable polymer particles (microgels).

### (Preparation Method)

The water-borne first base coating composition is prepared by mixing the above components by a publicly known method. The water-borne first base coating composition is diluted with a solvent such as water, as necessary, and subjected to coating.

### Water-Borne Second Base Coating Composition

The water-borne second base coating composition contains, for example, an aqueous resin similar to that of the water-borne first base coating composition, a curing agent, a second luster pigment, and a second coloring pigment. The water-borne second base coating composition may contain an extender pigment and an additive similar to those of the water-borne first base coating composition, as necessary.

The second coloring pigment includes two or more coloring pigments of the same series of color as the first coloring pigments. Three or more coloring pigments of the same series of color may be contained.

The solid component concentration NV2 of the water-borne second base coating composition is 7.0 to 30.0% by mass. When the solid component concentration NV2 is 7.0% by mass or more, the coating efficiency is improved. When the solid component concentration NV2 is 30.0% by mass or less, the FF property is improved. The solid component concentration NV2 may be 15.0% by mass or more. The solid component concentration NV2 may be 20.0% by mass or less.

The water-borne second base coating composition may contain a wettability improver such as a fluorine-containing compound or a silicone compound. As a result, the surface tension of the water-borne second base coating composition decreases, and the wettability to the first base coating film can be improved. The blending amount of the wettability improver may be 0.1 to 5.0 parts by mass per 100 parts by mass of the resin solid component of the water-borne second base coating composition.

Examples of the fluorine-containing compound include fluorinated alkyl carboxylates, fluorinated alkyl alkoxylates, and fluorinated alkyl esters.

Examples of a silicone-based additive include polyether-modified polymethylalkylsiloxane, polyether-modified polydimethylsiloxane, polyester-modified polymethylalkylsiloxane, silicone-modified acrylic polymers, and aralkyl-modified polymethylalkylsiloxane.

### (PWC_{G2} of Second Luster Pigment)

The PWC_{G2} of the second luster pigment is 5.0 to 35.0%. When the PWC_{G2} is 5.0% or more, sufficient brightness is obtained. When the PWC_{G2} is 35.0% or less, a good appearance is obtained. The PWC_{G2} may be 7.0% or more, and may be 9.0% or more. The PWC_{G2} may be 30% or less, and may be 25.0% or less.

The average particle size of the second luster pigment is not particularly limited. The average particle size of the second luster pigment may be, for example, 8.0 to 25 m in that a sparkle texture is easily improved.

The difference between the average particle size of the first luster pigment and the average particle size of the second luster pigment may be 5.0 μm or less. As a result, the difference in hue can be further reduced. The difference in average particle size may be 3.0 μm or less, may be 1.0 μm or less, and may be 0 μm.

### (PWC_{C2} of Second Coloring Pigment)

The PWC_{C2} of the second coloring pigment is 0.5 to 20.0%. When the PWC_{C2} is 0.5% or more, the hue of the second base coating film is easily adjusted, and the color difference from the multilayer coating film tends to be small. When the PWC_{C2} is 20.0% or less, the flip-flop property of the multilayer coating film can be improved. The PWC_{C2} may be 1.0% or more, and may be 1.5% or more. The PWC_{C2} may be 10.0% or less, may be 7.0% or less, and may be 5.0% or less.

### Clear Coating Composition

The clear coating composition may be a solvent-based composition, may be an water-borne composition, and may be a powder type composition. The clear coating composition may be a solvent-based composition. The clear coating composition may include the previously described coloring pigment as long as transparency is not impaired.

The clear coating composition may be, for example, an acid epoxy curable type containing a polyepoxide and a polycarboxylic acid, or a urethane curable type containing a hydroxy group-containing resin and a polyisocyanate compound. The urethane curable type clear coating composition may be a two-pack type.

The acid epoxy curable type clear coating composition contains, for example, (a) an acid anhydride group-containing aqueous acrylic resin, (b) a carboxyl group-containing polyester resin, and (c) an aqueous acrylic resin having a hydroxy group and an epoxy group. From the viewpoint of storage stability, the acid anhydride group of the acid anhydride group-containing aqueous acrylic resin (a) may have been half-esterified with a low molecular weight alcohol or the like. The carboxyl group-containing polyester resin (b) may further have a hydroxy group.

The resins (a) to (c) are blended such that, for example, the molar ratio of carboxyl groups contained in the aqueous acrylic resin (a) and the polyester resin (b) to epoxy groups contained in the aqueous acrylic resin (c) is 1/1.4 to 1/0.6 (preferably 1/1.2 to 1/0.8), and the molar ratio of carboxyl groups derived from acid anhydride groups contained in the aqueous acrylic resin (a) to hydroxy groups contained in the polyester resin (b) and the aqueous acrylic resin (c) is 1/2.0 to 1/0.5 (preferably 1/1.5 to 1/0.7).

The urethane curable type clear coating composition contains, for example, a hydroxy group-containing resin and a polyisocyanate compound. Examples of the polyisocyanate compound include those described above. Examples of the hydroxy group-containing resin include a polyester resin containing a hydroxy group, a polyurethane resin, an aqueous acrylic resin, and a polyol.

The OHV of the hydroxy group-containing resin is, for example, 20 mg KOH/g or more and 200 mg KOH/g or less. The OHV may be 30 mg KOH/g or more. The OHV may be 180 mg KOH/g or less. The Mw of the hydroxy group-containing resin is, for example, 1000 or more and 20000 or less. The Mw may be 2000 or more. The Mw may be 15000 or less. The AV of the hydroxy group-containing resin is, for example, 0 mg KOH/g or more and 30 mg KOH/g or less. The AV may be 25 mg KOH/g or less.

The hydroxy group-containing resin and the polyisocyanate compound are blended such that, for example, an equivalent ratio of isocyanate groups (NCO) to hydroxy groups (OH) (NCO/OH) is 0.5 or more and 1.7 or less. The equivalent ratio may be 0.7 or more. The equivalent ratio may be 1.5 or less.

In addition, an acrylic melamine curable type clear coating composition may be used. The clear coating composition may be a commercially available product.

The resin solid component concentration of the clear coating composition is not particularly limited, and is appropriately set according to coating conditions. The resin solid component concentration of the clear coating composition is, for example, 40 to 70% by mass.

### (Article to be Coated)

The material of the article to be coated is not particularly limited. Examples of the material of the article to be coated include metal, resin, and glass.

The shape of the article to be coated is not particularly limited. Examples of the article to be coated specifically include automobile bodies such as passenger cars, trucks, motorcycles, and buses, parts for automobile bodies, and automobile parts such as spoilers, bumpers, mirror covers, grilles, and door knobs.

Examples of the metal include iron, copper, aluminum, tin, zinc, and alloys thereof (e.g., steel). Examples of a metallic article to be coated typically include steel sheets such as cold-rolled steel sheets, hot-rolled steel sheets, stainless steels, electrogalvanized steel sheets, hot-dip galvanized steel sheets, zinc-aluminum alloy-based plated steel sheets, zinc-iron alloy-based plated steel sheets, zinc-magnesium alloy-based plated steel sheets, zinc-aluminum-magnesium alloy-based plated steel sheets, aluminum-based plated steel sheets, aluminum-silicon alloy-based steel sheets, and tin-based plated steel sheets.

The metallic article to be coated may have been subjected to surface treatment. Examples of the surface treatment include phosphate salt treatment, chromate treatment, zirconium chemical conversion treatment, and composite oxide treatment. The metallic article to be coated may have been further coated with an electrodeposition coating material after the surface treatment. The electrodeposition coating material may be of a cationic type or of an anionic type.

Examples of the resin include polyethylene resin, EVA resin, polyolefin resins (polyethylene resin, polypropylene resin, etc.), vinyl chloride resin, styrol resin, polyester resins (including PET resin, PBT resin, etc.), polycarbonate resin, acrylic resin, acrylonitrile-butadiene-styrene (ABS) resin, acrylonitrile-styrene (AS) resin, polyamide resin, acetal resin, phenol resin, fluororesin, melamine resin, urethane resin, epoxy resin, and polyphenylene oxide (PPO). The resin article to be coated may have been subjected to degreasing treatment. Resin portions may be primer-coated.

### [Method for Forming Multilayer Coating Film]

The multilayer coating film can be formed by a method including: applying a water-borne first base coating composition onto an article to be coated to form an uncured first base coating film; applying a water-borne second base coating composition onto the uncured first base coating film to form an uncured second base coating film; applying a clear coating composition onto the uncured second base coating film to form an uncured clear coating film; and heating the uncured first base coating film, the uncured second base coating film, and the uncured clear coating film.

When the second base coating composition is applied, the first base coating film may be either cured or uncured. When the second base coating composition is applied, the first base coating film may be uncured.

That is, the multilayer coating film may be produced by a method (3-coat 1-bake method) including a step of sequentially applying a first base coating composition, a second base coating composition, and a clear coating composition onto an article to be coated to form an uncured first base coating film, an uncured second base coating film, and an uncured clear coating film in this order; and a step of curing the uncured first base coating film, the uncured second base coating film, and the uncured clear coating film at once.

Examples of an application method include multistage application, preferably two-stage application, using air-spray application, airless-spray application, electrostatic spray application, or air-electrostatic spray application, or application combining air-electrostatic spray application and a rotary atomization type electrostatic applicator.

Curing of each coating composition is performed, for example, under conditions of a heating temperature of 80° C. to 180° C. and a heating time of 5 minutes to 60 minutes (preferably 10 minutes to 30 minutes).

Preheating may be performed between the application of the first base coating composition and the application of the second base coating composition, or between the application of the second base coating composition and the application of the clear coating composition. The preheating is performed, for example, by a method in which the item is left standing for 5 minutes or more and 15 minutes or less under a temperature condition of 20° C. or more and 25° C. or less, or a method in which the item is heated for 30 seconds or more and 10 minutes or less under a temperature condition of 50° C. or more and 80° C. or less. Preheating may not be performed between the application of the first base coating composition and the application of the second base coating composition.

In the preheating, at least a part of the solvent is intentionally removed. “Preheating is not performed” means that an operation of intentionally removing the solvent from the uncured first base coating film is not performed before the application of the second base coating composition. Examples of the method of intentionally removing the solvent (that is, the preheating method) include natural drying and heat drying. In the natural drying, for example, the uncured first base coating film is left standing for 5 minutes or more and 15 minutes or less under a temperature condition of 20° C. or more and 25° C. or less. The heat drying is performed under the condition that the curing reaction by the coating film-forming component does not proceed or at least the curing reaction is not completed. In the heat drying, the uncured first base coating film is heated for 30 seconds or more and 10 minutes or less under a temperature condition of, for example, 50° C. or more and 80° C. or less.

### Examples

Details of each component of the coating compositions used in Examples are as follows.

### Aqueous Resin 1 (Acrylic Resin Emulsion)

126.5 parts of deionized water was added to a reaction vessel, and the temperature was raised to 80° C. while mixing and stirring in a nitrogen stream. Subsequently, 100 parts of a monomer mixture of 27.61 parts of methyl acrylate, 53.04 parts of ethyl acrylate, 4.00 parts of styrene, 9.28 parts of 2-hydroxyethyl methacrylate, 3.07 parts of methacrylic acid, and 3.00 parts of allyl methacrylate, a monomer emulsion composed of 0.7 parts of Aqualon HS-10 (polyoxyethylene alkylpropenylphenyl ether sulfate, produced by DKS Co. Ltd.), 0.5 parts of ADEKA REASOAP NE-20 (α-[1-[(allyloxy)methyl]-2-(nonylphenoxy)ethyl]-o-hydroxyoxyethylene, produced by ADEKA Corp.), and 80 parts of deionized water, and an initiator solution composed of 0.3 parts of ammonium persulfate and 10 parts of deionized water were dropped in parallel into the reaction vessel over 2 hours. After the completion of the dropping, aging was carried out at that temperature for 2 hours. Subsequently, the mixture was cooled to 40° C. and filtered through a 400 mesh filter, and then 70 parts of deionized water and 0.32 parts of dimethylaminoethanol were added to adjust the resulting mixture to pH 6.5.

The acrylic resin emulsion obtained was a monolayer type having an average particle size of 150 nm, a non-volatile matter content of 20%, a solid component acid value of 20 mg KOH/g, and a hydroxyl value of 40 mg KOH/g.

### Aqueous Resin 2 (Water-Soluble Acrylic Resin)

23.89 parts of tripropylene glycol methyl ether and 16.11 parts of propylene glycol methyl ether were added to a reaction vessel, and the temperature was raised to 105° C. while mixing and stirring in a nitrogen stream. Subsequently, a monomer mixture of 13.1 parts of methyl methacrylate, 68.4 parts of ethyl acrylate, 11.6 parts of 2-hydroxyethyl methacrylate, and 6.9 parts of methacrylic acid was prepared, and 100 parts of the monomer mixture and an initiator solution composed of 10 parts of tripropylene glycol methyl ether and 1 part of tert-butyl peroxy-2-ethylhexanoate were dropped in parallel into the reaction vessel over 3 hours. After the completion of the dropping, aging was carried out at that temperature for 0.5 hours. Furthermore, an initiator solution composed of 5 parts of tripropylene glycol methyl ether and 0.3 parts of tert-butyl peroxy-2-ethylhexanoate was dropped into the reaction vessel over 0.5 hours. After the completion of the dropping, aging was carried out at that temperature for 2 hours. 16.1 parts of the solvent was distilled off at 110° C. under reduced pressure (70 torr) with a desolvating apparatus, and then, 204 parts of deionized water and 7.1 parts of dimethylaminoethanol were added.

The resulting water-soluble acrylic resin (B) had a non-volatile matter content of 30.0%, a solid component acid value of 40 mg KOH/g, and a hydroxyl value of 50 mg KOH/g.

### Aqueous Resin 3 (Polyether Polyol)

Trade name “Prime Pole PX-1000” manufactured by Sanyo Chemical Industries, Ltd., bifunctional polyether polyol, number-average molecular weight: 400, hydroxyl value: 278 mg KOH/g, primary/secondary hydroxyl value ratio=63/37, non-volatile matter content: 100%

### Aqueous Resin 4 (Urethane Resin Emulsion)

Trade name “NeoRez R-9603” manufactured by Avecia, polycarbonate-based urethane emulsion resin, non-volatile matter content: 33%

### Curing Agent

Trade name “CYMEL 204” manufactured by Mitsui Chemicals, Inc., mixed alkylated melamine resin, non-volatile matter content: 100%

### Luster Pigment 1

Trade name “ALPASTE (registered trademark) 06-0672” manufactured by Toyo Aluminium K.K., silver color, average particle size: 17 m

### Luster Pigment 2

Trade name “ALPASTE (registered trademark) WM-2025” manufactured by Toyo Aluminium K.K., silver color, average particle size: 15 m

### Luster Pigment 3

Trade name “ALPASTE (registered trademark) WL-4690” manufactured by Toyo Aluminium K.K., silver color, average particle size: 7 μm

### Coloring Pigment 1 (Color Index Name: P.BK.7)

Trade name “Raven 5000 Black” manufactured by Birla, black

### Coloring Pigment 2 (Color Index Name: P. B.15:1)

Trade name “Cyanine Blue G-314” manufactured by Sanyo Color Works, Ltd., blue

### Coloring Pigment 3 (Color Index Name: P. B.15:3)

Trade name “Cyanine Blue 3011” manufactured by Sanyo Color Works, Ltd., blue, having the same series of color as coloring pigment 2.

### Coloring Pigment 4 (Color Index Name: P.V.19Y)

Trade name “FASTOGEN SUPER RED 400RG” manufactured by DIC Corporation, red

### Coloring Pigment 5 (Color Index Name: P.BR.7)

Trade name “Bayferrox 120NM” manufactured by Lanxess, red

### Coloring Pigment 6 (Color Index Name: P.W.6)

Trade name “Tipaaque CR-97” manufactured by Ishihara Sangyo Kaisha, Ltd., white

### Coloring Pigment 7 (Color Index Name: P.V.23)

Trade name “Violet RL-NF” manufactured by Clariant, violet

### Tertiary Amine (Neutralizing Agent)

10% by mass aqueous solution of dimethylethanolamine

### Clear Coating Material

Trade name “MACFLOW 0-1810 Clear” manufactured by Nippon Paint Automotive Coatings Co., Ltd., acid epoxy curable type acrylic resin-based coating material

### Base Material

SPCC-SD steel sheet treated with zinc phosphate, dimensions: 20 cm×30 cm×thickness 0.8 cm

### Multiangle Spectrophotometer

Trade name “BYK-mac i” manufactured by BYK

### Examples 1 to 6 and Comparative Examples 1 to 5

### (1) Preparation of First Base Coating Composition (1bc)

In addition to a luster pigment and a coloring pigment of the formulations (PWC) shown in Tables 1 and 2, the following amounts of a resin component, a curing agent, and a tertiary amine were blended and uniformly dispersed, affording a first base coating composition.

Aqueous resin 1: 200 parts by mass (non-volatile matter content: 40 parts by mass)

Aqueous resin 2: 16.7 parts by mass (non-volatile matter content: 5 parts by mass)

Aqueous resin 3: 10 parts by mass (non-volatile matter content: 10 parts by mass)

Aqueous resin 4: 5 parts by mass (non-volatile matter content: 1.65 parts by mass)

Curing agent: 15.2 parts by mass (non-volatile matter content: 15.2 parts by mass)

Tertiary amine: 40 parts by mass (concentration: 10% by mass)

Corrosion inhibitor: 0.2 parts by mass (non-volatile matter content: 0.1 parts by mass)

### (2) Preparation of Second Base Coating Composition (2bc)

A luster pigment and a coloring pigment were blended as shown in Tables 1 and 2, and the same amounts of a resin component, a curing agent and a tertiary amine as those of the first base coating composition were blended and uniformly dispersed, affording a second base coating composition. The solid component concentration was adjusted by the amount of the solvent.

### (3) Formation of Multilayer Coating Film

A cationic electrodeposition coating material (trade name: “Power Top V-50”, manufactured by Nippon Paint Automotive Coatings Co., Ltd.) and an intermediate coating material (trade name: “OP-30”, manufactured by Nippon Paint Automotive Coatings Co., Ltd.) were applied to a base material (steel sheet), whereby an article to be coated was prepared.

Onto the article to be coated, the first base coating composition was applied with a spray gun such that a dry film thickness of 12 μm was attained. Subsequently, the second base coating composition was applied with a spray gun such that a dry film thickness of 4 μm was attained, and was preheated at a temperature of 80° C. for 3 minutes.

Next, the clear coating composition was applied such that a dry film thickness of m was attained. Finally, heating was performed at a temperature of 140° C. for 30 minutes, forming a multilayer coating film having a first base coating film, a second base coating film, and a clear coating film.

### Comparative Example 6

A first base coating composition and a second base coating composition were prepared in the same manner as in Example 1 except that luster pigments and coloring pigments were blended as shown in Tables 1 and 2.

A multilayer coating film was obtained in the same manner as in Example 1 except that both the resulting first base coating composition and second base coating composition were applied such that a dry film thickness of 7.5 μm was attained.

### [Evaluation]

### Lightness and Color Difference

A first base coating film for evaluation was prepared as follows.

First, a cationic electrodeposition coating material (trade name: “Power Top V-50”, manufactured by Nippon Paint Automotive Coatings Co., Ltd.) and an intermediate coating material (trade name: “OP-30”, manufactured by Nippon Paint Automotive Coatings Co., Ltd.) were applied to a base material (steel sheet), whereby an article to be coated was prepared. The first base coating composition was applied onto the article to be coated with a spray gun such that a dry film thickness of 10 μm was attained, and preheated at a temperature of 80° C. for 3 minutes, forming an uncured first base coating film. Subsequently, the clear coating composition described above was applied such that a dry film thickness of 10 μm was attained. Finally, heating was performed at a temperature of 140° C. for 30 minutes.

The Lbc*25 value, the Lbc*45 value, the Ebc*25 value, and the Ebc*45 value of the first base coating film for evaluation and the Lm*25 value, the Lm*45 value, the color difference Em*25 value, and the color difference Em*45 value of the multilayer coating film were measured using a multiangle spectrophotometer, and ΔL*25, ΔL*45, ΔE*25, and ΔE*45 were calculated.

### FF Property

Using a multiangle spectrophotometer, light I₄₅ applied to the surface of the multilayer coating film at an angle of 45 degrees was received at an angle of 15 degrees or 75 degrees with respect to specular reflection light, and the lightness Lm*15 and Lm*75 were measured. From these values, the ratio (Lm*15/Lm*75) was calculated, and the FF property was evaluated according to the following criteria. The larger the ratio (Lm*15/Lm*75) is, the better the FF property is.
A: The ratio (Lm*15/Lm*75) is 4 or more.
B: The ratio (Lm*15/Lm*75) is less than 4.

### Dust Streaks

An inner panel test panel 1 corresponding to an inner panel and an outer panel test panel corresponding to an outer panel (outer panel test panel 2A assuming a front door and outer panel test panel 2B assuming a rear door) were produced as follows.

### (a) Preparation of Inner Panel Test Panel 1

A cationic electrodeposition coating material (trade name: “Power Top V-50”, manufactured by Nippon Paint Automotive Coatings Co., Ltd.) and an intermediate coating material (trade name: “OP-30”, manufactured by Nippon Paint Automotive Coatings Co., Ltd.) were applied to a base material (steel sheet), whereby three articles to be coated were prepared. The first base coating composition was applied onto one article to be coated with a spray gun such that a dry film thickness of 10 μm was attained, thereby forming an uncured first base coating film. This was taken as the inner panel test panel 1 corresponding to an inner panel.

### (b) Preparation of Outer Panel Test Panel

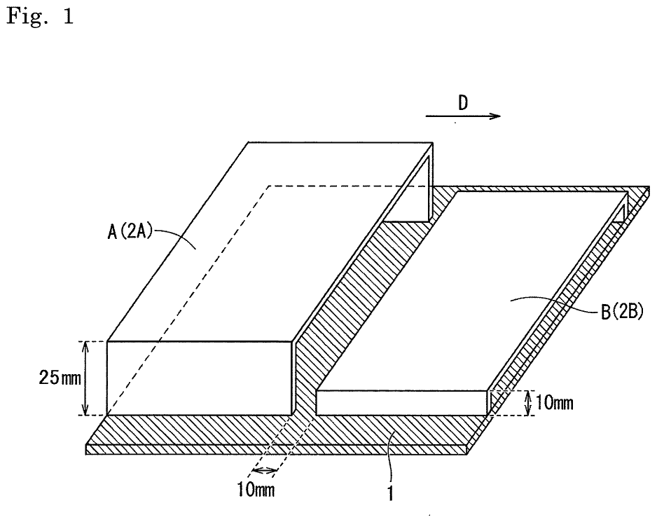

Next, as shown in FIG. 1, another article to be coated A was disposed above the inner panel test panel 1 such that the height from the surface of the inner panel test panel 1 to the surface of the article to be coated A was 25 mm. Still another article to be coated B was disposed such that the height from the surface of the inner panel test panel 1 to the surface of the article to be coated B was 10 mm. The distance between the article to be coated A and the article to be coated B was set to 10 mm.

Subsequently, the first base coating composition and the second base coating composition were applied in order from the left end of the article to be coated A to the right end of the article to be coated B depicted in FIG. 1 under standard robot coating conditions such that dry film thicknesses of 12 μm and 4 μm were attained, respectively. Then, preheating was performed at a temperature of 80° C. for 3 minutes. Thereafter, the clear coating composition was applied such that a dry film thickness of 30 μm was attained. Finally, baking was performed at a temperature of 140° C. for 30 minutes, thereby forming a multilayer coating film having a first base coating film, a second base coating film, and a clear coating film on the article to be coated A and the article to be coated B, whereby an outer panel test panel 2A assuming a front door was produced from the article to be coated A, and an outer panel test panel 2B assuming a rear door was produced from the article to be coated B.

The surface of the inner panel test panel 1 was visually checked, and dust streaks were evaluated according to the following criteria. When the rating is A, it can be said that the difference in hue between the first base coating film and the multilayer coating film is reduced.
A: Dust streaks can be slightly confirmed depending on the observation angle, but there is not much incompatibility.
B: Dust streaks can be confirmed depending on the observation angle, and there is incompatibility.
C: Dust streaks can be easily confirmed, and there is a clear incompatibility.

TABLE 1

| | | Example | | | | | | | | | | | |
|---|---|---|---|---|---|---|---|---|---|---|---|---|---|
| | | 1 | | 2 | | 3 | | 4 | | 5 | | 6 | |
| | | 1bc | 2bc | 1bc | 2bc | 1bc | 2bc | 1bc | 2bc | 1bc | 2bc | 1bc | 2bc |
| NV(%) | | 25.0 | 15.0 | 25.0 | 15.0 | 25.0 | 15.0 | 25.0 | 15.0 | 25.0 | 15.0 | 25.0 | 15.0 |
| NV1/NV2 | | 1.67/1 | | 1.67/1 | | 1.67/1 | | 1.67/1 | | 1.67/1 | | 1.67/1 | |
| Luster | 1 | | | 5.0 | 15.0 | 2.1 | 17.5 | | | 2.1 | 17.5 | | |
| pigment | 2 | 6.0 | 8.0 | 3.0 | 5.0 | | | 6.0 | 8.0 | | | 6.0 | 8.0 |
| (PWC) | 3 | | 3.0 | | | | | | 3.0 | | | | 3.0 |
| | Total PWC_{G} (%) | 6.0 | 11.0 | 8.0 | 21.0 | 2.1 | 17.5 | 6.0 | 11.0 | 2.1 | 17.5 | 6.0 | 11.0 |
| PWC_{G1}/PWC_{G2} | | 1/1.9 | | 1/2.5 | | 1/8.3 | | 1/1.9 | | 1/8.3 | | 1/1.9 | |
| Coloring | P.BK.7 | 1.4 | 2.3 | 0.2 | 0.2 | 1.2 | 2.0 | 1.4 | 3.3 | 0.6 | 4.0 | 1.4 | 0.9 |
| pigment | P.B.15:1 | | 0.9 | 0.2 | 0.3 | 0.3 | 0.5 | | 1.5 | 0.2 | 1.0 | | 0.5 |
| (PWC) | P.B.15:3 | 0.4 | | | | | | 0.4 | | | | 0.4 | |
| | P.V.19Y | 0.3 | 0.7 | 0.05 | 0.3 | | | 0.3 | 2.0 | | | 0.3 | 0.5 |
| | P.BR.7 | | 0.6 | 0.02 | | | | | 0.6 | | | | 0.3 |
| | P.W.6 | | 0.8 | | 0.1 | 0.6 | | | 0.8 | 0.3 | | | 0.2 |
| | P.V.23 | | | | | 0.1 | 0.2 | | | 0.1 | 0.4 | | |
| | Total PWC_{C} (%) | 2.1 | 5.3 | 0.5 | 0.9 | 2.2 | 2.7 | 2.1 | 8.2 | 1.2 | 5.4 | 2.1 | 2.4 |

| PWC_{C1}/PWC_{C2} | | 1/2.5 | 1/1.8 | 1/1.2 | 1/3.9 | 1/4.5 | 1/1.2 |
|---|---|---|---|---|---|---|---|
| T1/T2 | | 3/1 | 3/1 | 3/1 | 3/1 | 3/1 | 3/1 |
| Hue | Lm*25 | 65.7 | 91.3 | 49.1 | 63.5 | 48.5 | 67.5 |
| | Lm*45 | 31.4 | 44.3 | 16.5 | 27.0 | 15.3 | 33.8 |
| | Lbc*25 | 62.3 | 89.5 | 43.6 | 62.3 | 44.6 | 62.3 |
| | Lbc*45 | 34.5 | 51.7 | 23.1 | 34.5 | 24.8 | 34.5 |
| | ΔL25(≤10) | 3.4 | 1.8 | 5.5 | 1.2 | 3.9 | 5.2 |
| | ΔL45(≤10) | −3.1 | −7.4 | −6.6 | −7.5 | −9.5 | −0.7 |
| | ΔE25(≤10) | 4.1 | 4.3 | 5.7 | 3.5 | 3.6 | 6.2 |
| | ΔE45(≤10) | 3.4 | 7.9 | 7.2 | 8.9 | 9.7 | 2.4 |
| Evaluation | Dust streaks | A | A | A | A | A | A |
| | FF property | A | A | A | A | A | A |

TABLE 2

| | | Comparative Example | | | | | | | | | | | |
|---|---|---|---|---|---|---|---|---|---|---|---|---|---|
| | | 1 | | 2 | | 3 | | 4 | | 5 | | 6 | |
| | | 1bc | 2bc | 1bc | 2bc | 1bc | 2bc | 1bc | 2bc | 1bc | 2bc | 1bc | 2bc |
| NV(%) | | 25.0 | 15.0 | 25.0 | 15.0 | 25.0 | 15.0 | 25.0 | 15.0 | 25.0 | 15.0 | 25.0 | 25.0 |
| NV1/NV2 | | 1.67/1 | | 1.67/1 | | 1.67/1 | | 1.67/1 | | 1.67/1 | | 1/1 | |
| Luster | 1 | | 10.0 | 5.0 | 15.0 | 5.0 | 15.0 | | | | | | |
| pigment | 2 | 2.0 | 2.0 | 3.0 | 5.0 | 3.0 | 5.0 | 6.0 | 8.0 | 6.0 | 8.0 | 6.0 | 6.0 |
| (PWC) | 3 | | | | | | | | 3.0 | | 3.0 | | |
| | Total PWC_{G} (%) | 1.0 | 12.0 | 8.0 | 21.0 | 8.0 | 21.0 | 6.0 | 11.0 | 6.0 | 11.0 | 6.0 | 6.0 |
| PWC_{G1}/PWC_{G2} | | 1/12 | | 1/2.5 | | 1/2.5 | | 1/1.9 | | 1/1.9 | | 1/1 | |
| Coloring | P.BK.7 | 0.2 | 0.2 | 0.7 | 0.2 | 0.2 | 1.8 | 1.4 | 2.3 | | 2.3 | 0.4 | 0.4 |
| pigment | P.B.15:1 | 0.2 | 0.3 | 0.2 | 0.3 | 0.2 | 1.7 | | 0.9 | | 0.9 | 0.2 | 0.2 |
| (PWC) | P.B.15:3 | | | | | | | | | | | | |
| | P.V.19Y | 0.05 | 0.3 | 0.1 | 0.3 | 0.05 | 0.5 | | 0.7 | | 0.7 | 0.2 | 0.2 |
| | P.BR.7 | 0.02 | | 0.03 | | 0..02 | 0.1 | | 0.6 | | 0.6 | | |
| | P.W.6 | | 0.1 | | 0.1 | | 0.1 | | 0.8 | | 0.8 | 1.0 | 1.0 |
| | P.V.23 | | | | | | | | | | | | |
| | Total PWC_{C} (%) | 0.5 | 0.9 | 1.03 | 0.9 | 0.5 | 4.2 | 1.4 | 5.3 | 0 | 5.3 | 1.8 | 1.8 |

| PWC_{C1}/PWC_{C2} | | 1/1.8 | 1.1/1 | 1/8.4 | 1/3.8 | 0/5.3 | 1/1 |
|---|---|---|---|---|---|---|---|
| T1/T2 | | 3/1 | 3/1 | 3/1 | 3/1 | 3/1 | 1/1 |
| Hue | Lm*25 | 72.4 | 91.3 | 89.6 | 65.7 | 65.9 | 65.2 |
| | Lm*45 | 32.6 | 43.2 | 38.2 | 31.6 | 32.1 | 34.6 |
| | Lbc*25 | 38.5 | 82.1 | 89.5 | 64.5 | 70.3 | 65.2 |
| | Lbc*45 | 35.9 | 40.2 | 51.7 | 39.2 | 48.2 | 34.5 |
| | ΔL25(≤10) | 33.9 | 9.2 | 0.1 | 1.2 | −4.4 | 0 |
| | ΔL45(≤10) | −3.3 | 3.0 | −13.5 | −7.6 | −16.1 | 0 |
| | ΔE25(≤10) | 36.2 | 11.2 | 4.9 | 4.3 | 8.2 | 0 |
| | ΔE45(≤10) | 7.6 | 6.5 | 10.7 | 12.4 | 19.4 | 0 |
| Evaluation | Dust streaks | C | B | C | C | C | A |
| | FF property | A | A | A | A | A | B |

In Examples 1 to 6, the difference in hue between the first base coating film and the multilayer coating film was small, and the generation of dust streaks was reduced. In addition, the products were superior in FF property.

In Comparative Example 1, the PWC ratio of the luster pigments was out of the prescribed range, and generation of dust streaks was observed. In Comparative Examples 2 and 3, the ratio of PWC of the coloring pigments was out of the prescribed range, and generation of dust streaks was observed. In Comparative Examples 4 and 5, since only one coloring pigment of the same series of color was contained or no coloring pigment of the same series of color was contained, generation of dust streaks was observed. In Comparative Example 6, since the first base coating composition and the second base coating composition were the same, the product was poor in FF property.

According to the multilayer coating film of the present invention, there is provided a multilayer coating film in which a difference in hue between the first base coating film and the multilayer coating film is small and with which a high flip-flop property is obtained. The multilayer coating film of the present invention is suitable for coating of an outer panel part when a first base coating film is formed on an outer panel part and an inner panel part of an automobile body using the same first base coating composition.

### REFERENCE SIGNS LIST

A, B Article to be coated
1 Inner panel test panel
2A Outer panel test panel
2B Outer panel test panel

1. A multilayer coating film comprising:
a first base coating film formed from a water-borne first base coating composition on an article to be coated;
a second base coating film formed from a water-borne second base coating composition on the first base coating film; and
a clear coating film formed from a clear coating composition on the second base coating film, wherein
in the water-borne first base coating composition, a luster pigment and two or more coloring pigments are contained,
a solid component concentration NV1 is 20 to 35% by mass,
PWC_{G1} of the luster pigment is 1 to 25%, and
PWC_{C1} of the coloring pigments is 0.1 to 5.0%;
in the water-borne second base coating composition, a luster pigment and two or more coloring pigments each having a same Color Index name as those of the coloring pigments contained in the water-borne first base coating composition are contained,
a solid component concentration NV2 is 7 to 30% by mass,
PWC_{G2} of the luster pigment is 5 to 35%, and
PWC_{C2} of the coloring pigments is 0.5 to 20.0%;
a ratio (T1/T2) of a thickness T1 of the first base coating film to a thickness T2 of the second base coating film is 1.5/1 to 5/1;
a ratio (NV1/NV2) of the solid component concentration NV1 to the solid component concentration NV2 is 1.3/1 to 3/1;
a ratio (PWC_{G}i/PWC_{G2}) of the PWC_{G1} of the luster pigment to the PWC_{G2} of the luster pigment is 1/10 to 1/1; and
a ratio (PWC_{c}i/PWC_{C2}) of the PWC_{C1} of the coloring pigments to the PWC_{C2} of the coloring pigments is 1/5 to 1/1.

2. The multilayer coating film according to claim 1, wherein
on the basis of a spectral reflectance of light I₄₅ illuminated at an angle of 45 degrees with respect to a surface of a coating film and received at an angle of 25 degrees deviated from specular reflection light, for a lightness L*25 value, and a color difference E*25 value calculated from the lightness L*25 value, an a*25 value, and a b*25 value,
a value ΔL*25 determined by subtracting a lightness Lbc*25 of the first base coating film from a lightness Lm*25 value of the multilayer coating film is 0 to 10, and
a difference ΔE*25 between a color difference Em*25 value of the multilayer coating film and a color difference Ebc*25 of the first base coating film is 10 or less;
on the basis of a spectral reflectance of light I₄₅ illuminated at an angle of 45 degrees with respect to the surface of the coating film and received at an angle of 45 degrees deviated from specular reflection light, for a lightness L*45 value, and a color difference E*45 value calculated from the lightness L*45 value, an a*45 value, and a b*45 value,
a value ΔL*45 determined by subtracting a lightness Lbc*45 of the first base coating film from a lightness Lm*45 value of the multilayer coating film is −10 to 0, and
a difference ΔE*45 between a color difference Em*45 value of the multilayer coating film and a color difference Ebc*45 of the first base coating film is 10 or less.

3. The multilayer coating film according to claim 1, wherein a difference between an average particle size of the luster pigment contained in the water-borne first base coating composition and an average particle size of the luster pigment contained in the water-borne second base coating composition is 5 μm or less.

4. The multilayer coating film according to claim 2, wherein a difference between an average particle size of the luster pigment contained in the water-borne first base coating composition and an average particle size of the luster pigment contained in the water-borne second base coating composition is 5 μm or less.
